(19) United States
(12) Patent Application Publication
(10) Pub. No.: US 2019/0255959 A1
(43) Pub. Date: Aug. 22, 2019

(54) BATTERY FOR AN ELECTRICALLY DRIVEN MOTOR VEHICLE AND CHARGING DEVICE FOR CHARGING A BATTERY OF AN ELECTRICALLY DRIVEN MOTOR VEHICLE

(71) Applicant: AUDI AG, Ingolstadt (DE)

(72) Inventor: Daniel RUPPERT, Lenting (DE)

(73) Assignee: AUDI AG, Ingolstadt (DE)

(21) Appl. No.: 16/281,554

(22) Filed: Feb. 21, 2019

(30) Foreign Application Priority Data
Feb. 21, 2018 (DE) 102018202589.4

(51) Int. Cl. B60L 53/16; B60L 53/53; B60L 58/22; H02J 1/14; H02J 7/00; H02J 7/14

(52) U.S. Cl. CPC B60L 53/16; B60L 53/53; H02J 7/14; H02J 1/14; H02J 7/0027; B60L 58/22

(57) ABSTRACT

A battery for an electrically driven motor vehicle, including a plurality of battery cells which are interconnected to form respective cell clusters with a voltage of less than 60 Volt, each of them having an outside accessible connection for charging the cell cluster. A charging device for charging a battery of an electrically driven motor vehicle, having a charging interface with one respective plug connector for each cell cluster of the motor vehicle, the plug connector having a maximum charging voltage of less than 60 V.

### FIELD

A battery for an electrically driven motor vehicle, and a charging device for charging a battery of an electrically driven motor vehicle. Furthermore, the exemplary embodiments of the invention also relates to a motor vehicle having such a battery.

### BACKGROUND

Electric vehicles today often have a so-called combo charging socket, making possible a charging with direct current and also a charging with alternating current. Such combo charging sockets are widespread primarily in Europe. In other countries, such as China and Japan, separate connection systems are also customary. Furthermore, inductive charging systems are also being often developed at present, making possible a noncontact charging of electric vehicles, but with comparatively low power.

A traditional charging by cable usually requires an active inserting of a charging cable on the respective motor vehicle. Cable-free charging usually requires a rather complex inductive charging system on the vehicle side and also on the infrastructure side. Inductive charging or cable-free charging as such may therefore be relative prone to error and also be cost-intensive. Moreover, in cable-free charging the requirements on the most exact positioning possible for the electric vehicle being charged and also with regard to the detecting of foreign bodies are very high. Furthermore, the efficiency during a noncontact energy transfer is lower, which results in greater losses for such charging systems. Moreover, cable-free charging systems are by their nature rather significantly limited in power.

DE 10 2010 027 670 A1 shows a method for connecting an electrical energy accumulator of an electric vehicle to a charging station. A sensor unit of the charging unit detects a position of a vehicle-side charging connection, which is automatically connected to the charging station.

DE 10 2015 223 993 A1 shows a device for monitoring an energy transfer device. An introducing device here serves for the automatic connecting of a contact head of the energy transfer device to a charging socket of a vehicle.

DE 10 2012 216 980 A1 shows a vehicle charging station served by a robot. A robot arm of the robot comprises a gripping member, having several electrical contacts, which are designed for automatic coupling with a vehicle-side receptacle.

### SUMMARY

A problem which may be solved is to provide a solution by means of which a battery of an electrically driven motor vehicle can be charged especially easily and safely.

A problem is solved by a battery for an electrically driven motor vehicle and by a charging device for charging a battery of an electrically driven motor vehicle with the features of the independent patent claims. Advantageous embodiments with expedient and nontrivial modifications of the invention are indicated in the dependent claims.

The battery according to the invention for an electrically driven motor vehicle comprises a plurality of battery cells which are interconnected to form respective cell clusters with a voltage of less than 60 Volt, each of them having an outside accessible connection for charging the cell cluster. Outside accessible means here that the respective connections of the cell clusters are accessible with respect to the outside of the battery. Thus, for example, openings may be provided in a battery housing of the battery, affording an access to the respective connections of the individual cell clusters. Thus, the respective connections of the individual cell clusters can be led to the outside and made accessible for example via a charging plug on the motor vehicle, in which the battery is installed or situated, for example on the underfloor.

Thanks to the low voltage of the respective cell clusters of less than 60 Volt, there are no special high-voltage requirements for the battery or also for the respective electrically driven motor vehicle in which the battery is installed. Instead, traditional medium-voltage requirements are easily satisfied. The term “high-voltage” in the automotive industry means voltages above 60 Volt. Thanks to the low voltage of the respective cell clusters according to the invention, each of which have the mentioned connections for charging the cell cluster, it is possible to employ plug contacts, cables, and the like in a cost-effective manner and without the provisions required for high-voltage systems.

Thus, for example, a charging device in the form of a low-voltage charging robot can be used for the charging of the battery according to the invention, which charges the battery with a maximum d c voltage of less than 60 Volt. The battery itself according to the invention is preferably a high-voltage battery. This means that the battery in its entirety can provide a voltage greater than 60 Volt, among other things in order to supply energy to an electrical drive machine of a motor vehicle, for example.

The battery according to an embodiment of the invention makes possible a particularly high-power yet still comfortable charging of the battery, especially as compared to inductive charging solutions. In particular, the individual cell clusters of the battery can also be charged in a much more robust manner than with inductive charging. Furthermore, there is a much greater efficiency when charging the cell clusters of the battery than with inductive charging, so that the end customer also has lower electricity costs. In particular, the battery according to the invention makes possible a very safe voltage level, since the individual cell clusters are interconnected with less than 60 Volt and accordingly also need to be charged with a charging voltage of less than 60 Volt. For voltages below 25 Volt a.c. or 60 Volt d.c., no electrocution protection at all is needed. Depending on the voltage which the battery according to the invention needs to provide, different numbers of said cell clusters can be interconnected with the battery, for example. Furthermore, the battery according to the invention is independent of any high-voltage level of the electrically driven motor vehicle in which the battery is installed.

One advantageous embodiment of the invention proposes that the battery comprises nine of these cell clusters, which are connected in series with each other. Thus, for example, the battery can provide a voltage of around 220 to 460 Volt, where the individual cell clusters as such have a voltage of less than 60 Volt and accordingly do not need to be charged in the high-voltage range. Of course, the battery may also have more or fewer than said cell clusters.

One advantageous embodiment of the invention proposes that the cell clusters each have a d.c. voltage transformer for the balancing of the battery cells. Thus, a balancing can be done for each cell cluster during a charging process of the battery. During a charging process, it can thus be assured that the most uniform possible electrical charge distribution occurs within the individual cells of the cell cluster. Hence, the overall capacity of the cell clusters and ultimately therefore also that of the battery can be utilized, and a change over time in the individual cells due to aging can be prevented.

Another advantageous embodiment of the invention proposes that the battery cells are interconnected to form respective modules, wherein several of the modules are interconnected to form the cell clusters. The modules for example may have separate housings in which the individual battery cells are at first interconnected, the individual cell clusters being in turn composed of the individual modules. Thus, for example, it is possible with a view to a particular crash safety to arrange and interconnect the battery cells in especially stable individual modules. The individual cell clusters may then be interconnected in turn on the basis of the resulting modules. Furthermore, it is also possible, for example, for the automobile maker to directly order the battery cells so interconnected and arranged to form the modules and then to interconnect these modules according to its own requirements to form the respective cell clusters.

The motor vehicle according to the invention comprises at least one electric machine for driving the motor vehicle and the battery according to the invention or an advantageous embodiment of the battery according to the invention for the power supply of the electric machine, wherein the respective connections of the cell clusters are connected to a vehicle-side charging interface, having a plug connector for each cell cluster. The individual plug connectors may be plugs or also sockets, for example. Thus, the charging interface of the motor vehicle will make it possible to charge the individual cell clusters via the respective plug connectors, whether they be sockets and/or plugs. Preferably, the charging interface is arranged on an underfloor of the motor vehicle. Thus, the user of the motor vehicle can position it above a suitable charging device and then the battery of the motor vehicle can be charged in easy manner from underneath, preferably without the user of the motor vehicle having to handle a charging cable or the like.

Another advantageous embodiment of the motor vehicle proposes that the motor vehicle comprises a further charging interface, which is connected to a plus pole and a minus pole of the battery. By means of this charging interface, it is preferably possible to charge the battery with a high voltage. Thus, for example, public or also private charging columns and other charging devices can be used that are designed for traditional high-voltage batteries. Thus, the user of the motor vehicle has the option of choosing which of the charging interfaces they want to use in order to charge the battery of the motor vehicle.

The charging device according to the invention for charging a battery of the electrically driven motor vehicle according to the invention or an advantageous embodiment of the electrically driven motor vehicle comprises a charging interface with one respective plug connector for each cell cluster of the motor vehicle, wherein the plug connectors have a maximum charging voltage of less than 60 V. The charging device as such is therefore also not subject to the especially strict rules in regard to the high-voltage range. Since the individual plug connectors of the charging device for its part only have a maximum voltage of less than 60 Volt, the precautions otherwise needed in the high-voltage range do not necessarily need to be adopted for the charging device according to the invention.

One advantageous embodiment of the charging device proposes that the charging device is an underfloor charging device. The charging device may be arranged for example embedded in a parking place or also in a roadway, so that the user may easily position their electrically driven motor vehicle above the underfloor charging device and then charge the battery of their motor vehicle. Preferably, the charging interface of the charging device can extend and retract in the vertical direction. This may especially preferably occur fully automatically, so that the driver only needs to position their motor vehicle above the charging interface, after which the charging interface is then extended in the vertical direction in order to charge the motor vehicle. After the charging is complete, the charging interface may be retracted again, preferably fully automatically, so that the motor vehicle can exit from the charging device with no problem.

### BRIEF DESCRIPTION OF DRAWINGS

Further benefits, features and details of the invention will emerge from the following description of a preferred exemplary embodiment and with the aid of the drawing. The features and combinations of features mentioned above in the description as well as the features and combinations of features shown below in the description of the figures and/or in the figures alone can be used each time not only in the particular indicated combination, but also in other combinations or standing along, without leaving the scope of the invention.

The drawing shows:

FIG. 1 a schematic representation of an electrically driven motor vehicle, which can be charged both by means of a traditional charging column and also by means of an underfloor charging device having several connectors;

FIG. 2 a schematic representation of a high-voltage system of the motor vehicle, including among other things a high-voltage battery and an electrical machine for driving the motor vehicle; and

FIG. 3 a schematic representation of one of several cell clusters from which the high-voltage battery of the motor vehicle is constructed.

### DETAILED DESCRIPTION

In the figures, the same or functionally identical elements are given the same reference numbers.

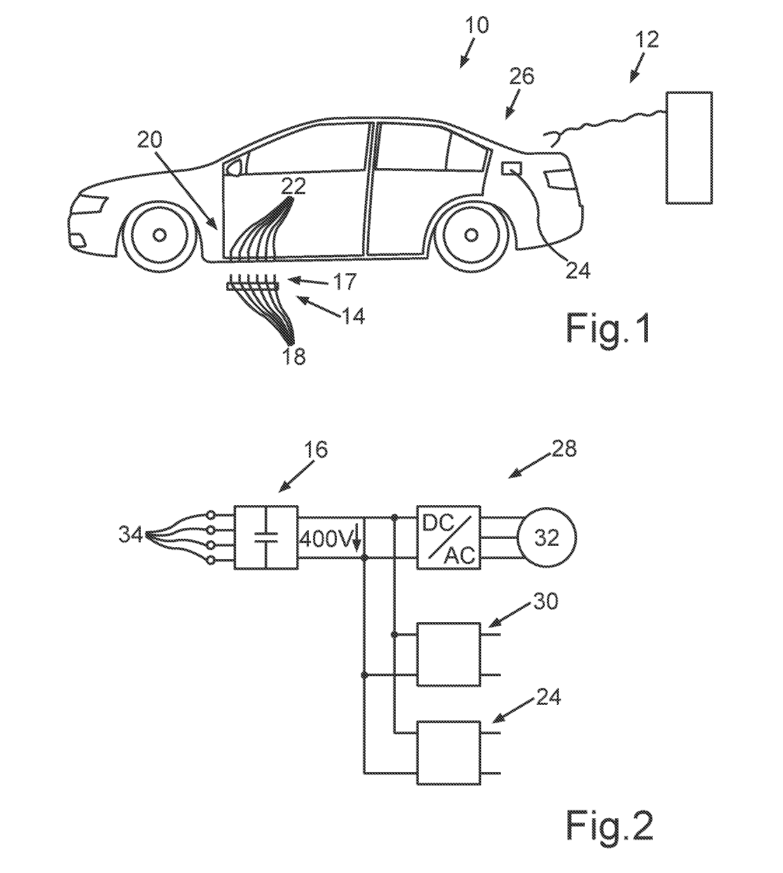

A motor vehicle 10, which is situated next to a charging column 12 and above a charging device 14 designed as an underfloor charging device, is shown in a schematic side view in FIG. 1. A high-voltage battery 16 of the motor vehicle 10, shown in FIG. 2, can be charged both by means of the charging column 12 and by means of the underfloor charging device 14.

The underfloor charging device 14 comprises a charging interface 17 with several plug connectors 18. The motor vehicle 10 in turn comprises a vehicle-side charging interface 20, which in turn has several plug connectors 22. The individual plug connectors 18 of the underfloor charging device 14 can provide a maximum charging voltage of less than 60 Volt.

The motor vehicle 10 furthermore comprises a further vehicle-side charging interface 24. A charging plug 26 of the charging column 12 can be inserted into this charging interface 24 for the charging of the high-voltage battery 16 not shown here. The charging interface 24 is connected to a plus pole and a minus pole of the high-voltage battery 16, not shown here. If the high-voltage battery 16 has for example a voltage of 400 Volt, then the high-voltage battery 16 can be charged via the charging column 12 likewise with a charging voltage of 400 Volt, for example.

FIG. 2 shows schematically a high-voltage system 28 of the motor vehicle 10. The high-voltage system 28 includes, besides the already mentioned high-voltage battery 16 and the vehicle-side charging interface 24, also an on-board network 30 and an electric machine 32 for driving the motor vehicle 10. The high-voltage battery 16 comprises a plurality of battery cells, not otherwise designated or represented here, which are interconnected to form respective cell clusters, also not represented here, with a voltage of less than 60 Volt. The individual cell clusters each have an outside accessible connection 34 for charging the individual cell clusters. The connections 34 are preferably connected to the respective plug connectors 22 of the vehicle-side charging interface by a corresponding wiring. Thus, by their design, a voltage of less than 60 Volt is always present on the individual plug connectors 22.

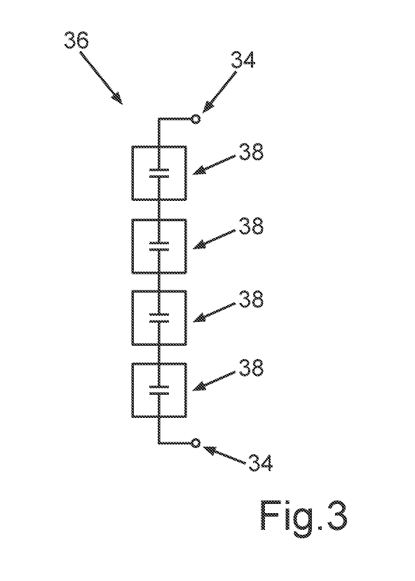

FIG. 3 shows schematically one of these cell clusters 36. The cell cluster 36 here is composed for example of a plurality of interconnected battery modules 38. The individual battery modules 38 in turn comprise the respective battery cells, not otherwise designated or shown here. The connections 34 for the cell clusters 36 to charge the cell cluster 36 are again schematically suggested here. Thus, a voltage greater than or equal to 60 Volt can never be present between the two connections 34 of the cell cluster 36 shown here. As already mentioned, the high-voltage battery 16 comprises a plurality of these cell clusters 36, for example the high-voltage battery 16 may be constructed from nine such cell clusters 36.

When using the underfloor charging device 14, the charging voltage is thus always less than 60 Volt. The charging interface 17 of the underfloor charging device 14 together with its plug connectors 18 may preferably be extended upward in fully automatic manner, so that the plug connectors 18 can make contact with the plug connectors 22 of the vehicle-side charging interface 20. After a charging of the high-voltage battery 16 is completed, the underfloor charging device 14 can once more also preferably fully automatically lower and thus retract its charging interface 17.

Thanks to the explained construction of the high-voltage battery 16 and the corresponding construction of the underfloor charging device 14, one thus has the possibility of charging the high-voltage battery 16 in an especially easy, comfortable and safe manner, without having to provide particularly costly plug contacts and cables as are otherwise required for the charging of high-voltage batteries. This is because the usual high-voltage requirements do not exist thanks to the low voltage of the individual cell clusters 36 at least with regard to the vehicle-side charging interface 20 and with regard to the underfloor charging device 14.

1. A battery for an electrically driven motor vehicle, comprising:
a plurality of battery cells which are interconnected to form respective cell clusters with a voltage of less than 60 Volts each of them having an outside accessible connection for charging the cell cluster.

2. The battery as claimed in claim 1, wherein the battery comprises nine of these cell clusters, which are connected in series with each other.

3. The battery as claimed in claim 1, wherein the cell clusters each have a d.c. voltage transformer for the balancing of the battery cells.

4. The battery as claimed in claim 1, wherein the battery cells are interconnected to form respective modules, wherein several of the modules are interconnected to form the cell clusters.

5. A motor vehicle with at least one electric machine for driving the motor vehicle and with a battery, comprising:
a plurality of battery cells which are interconnected to form respective cell clusters with a voltage of less than 60 Volts each of them having an outside accessible connection for charging the cell cluster with a power supply of the electric machine, wherein the respective connections of the cell clusters are connected to a vehicle-side charging interface, having a plug connector for each cell cluster.

6. The motor vehicle as claimed in claim 5, wherein the charging interface is arranged on an underfloor of the motor vehicle.

7. The motor vehicle as claimed in claim 5, wherein the motor vehicle comprises a further charging interface, which is connected to a plus pole and a minus pole of the battery.

8. A charging device for charging a battery of an electrically driven motor vehicle as claimed in claim 5, having a charging interface with one respective plug connector for each cell cluster of the motor vehicle, wherein the plug connectors have a maximum charging voltage of less than 60 V.

9. The charging device as claimed in claim 8, wherein the charging device is an underfloor charging device.

10. The charging device as claimed in claim 9, wherein the charging interface of the charging device can extend and retract in the vertical direction.
